(19) United States
(12) Patent Application Publication
(10) Pub. No.: US 2013/0003387 A1
(43) Pub. Date: Jan. 3, 2013

(54) LAMP

(75) Inventors: Shen-guan Shih, Taipei City (TW); Yu-Ren Ho, Taipei City (TW); Li-Chen Hsu, Taipei City (TW)

(73) Assignee: National Taiwan University of Science and Technology, Taipei City (TW)

(21) Appl. No.: 13/435,138

(22) Filed: Mar. 30, 2012

(30) Foreign Application Priority Data
Jun. 29, 2011 (TW) 100122890

(51) Int. Cl. F21V 7/00

(52) U.S. Cl. 362/296.01

(57) ABSTRACT

Disclosed is a lamp, which includes a luminous body, a power generating device, and a reflective body. The luminous body is utilized to emit light. The power generating device is utilized to generate power which is outputted through an outlet means. The reflective body, floating above the outlet means by the power, reflects the light of the luminous body to form an unexpected dynamic lighting effect. Moreover, a variation of the light can be changed by replacing the reflective body, such as a ball, or changing the strength of the power.

### TECHNICAL FIELD OF THE INVENTION

The present invention relates to a lamp, especially to a dynamic lamp.

### BACKGROUND OF THE INVENTION

A lamp has been used as an illuminating aide in people's lives. In recent years, consumers are more aware of advance in life, and hence their tastes in illuminating aides are improved, such that home lighting is playing an important role in making atmosphere special. In the past, we have only noticed whether the lamp is bright for people's visual assistance in the configuration of the home lighting. The requirements of the lamps for most people are not much, just clear and bright.

To date, the lamp is not only utilized to illuminate. The lamp plays an indispensable role in decorative and ornamental of indoor environments to build atmosphere, thereby generating different effects of situations and so on. An environment lamp is usually utilized to achieving the effect of changing indoor atmosphere, in which the environment lamp In general, a luminous body of the lamp is fixed, that is, it is disposed in a fixed position. To generate a dynamic effect of light beams, a mechanical device is usually utilized to move or rotate the luminous body, such as a stage illumination with a rotatable lampshade, thereby generating the dynamic effect of the light beams.

However, changes of the light beams are limited through the mechanical device to move the luminous body or rotate the lampshade. For example, the changes have only several regular segments, but it is extremely difficult to simulate the dynamic effect of the light beams waving in the wind like candlelight.

Accordingly, there is a significant need to improve an environment lamp for solving the drawback existing in the prior art.

### SUMMARY OF THE INVENTION

An objective of the present invention is to provide a lamp, which has a floating reflective body illuminated by light beams for creating various atmospheres and dynamic effect of lights and shadows, so as to solving the drawback of the conventional environment lamp.

To achieve the foregoing objectives, an lamp provided in the present invention includes a luminous body, a power generating device, and a reflective body. The luminous body is utilized to generate a light beam. The power generating device is utilized to generate a power which is outputted through outlet means. The reflective body, which floats above the outlet means by the power, is used for reflecting the light beam of the luminous body. In addition, a floating height of the reflective body is changed according to a strength of the power, or is rotated according to a direction of the power.

In one preferred embodiment, the luminous body is an indirect light source. The luminous body is located inside the outlet means, and the light beam is emitted from the outlet means.

The power is magnetic force or airflow. In one preferred embodiment, the airflow is an upward airflow which is outputted from the outlet means. Preferably, the power generating device is a fan, such as a fan of an air purifier. The reflective body is globular, and a floating height of that changes according to the strength of the power.

In the preferred embodiment, the outlet means is tubular. In addition, the lamp further comprises a base which is coupled to the outlet means for providing the lamp with a placement of center of gravity, and the base is further utilized to provide a user to place the reflective body.

In accordance with the present invention, the lamp which employs tubular outlet means and the power generating device make a ball float in the air, and the reflected light beam from the ball forms an unexpected dynamic effect of lights and shadows. Furthermore, it can generate various changes of the light beam by means of simply replacing the ball or changing the strength and direction of the power generated from the power generating device. The lamp of the present invention overcomes the drawback that the luminous body is moved or rotated to form only several regular changes of the light beam.

It is to be understood that both the foregoing general description and the following detailed description of the present invention are exemplary and explanatory and are intended to provide further explanation of the invention as claimed.

### BRIEF DESCRIPTION OF THE DRAWINGS

FIG. 1 depicts a perspective view illustrating a lamp in one preferred embodiment of the present invention; and

FIG. 2 depicts a cross-sectional diagram illustrating a lamp according to the preferred embodiment;

FIG. 3 depicts a top view illustrating a power generating device in one preferred embodiment of the present invention;

FIG. 4 is a pattern illustrating the lamp of the preferred embodiment projecting on a ceiling; and

FIG. 5 is a schematic drawing illustrating a lamp according to another preferred embodiment of the present invention.

### DETAILED DESCRIPTION OF THE INVENTION

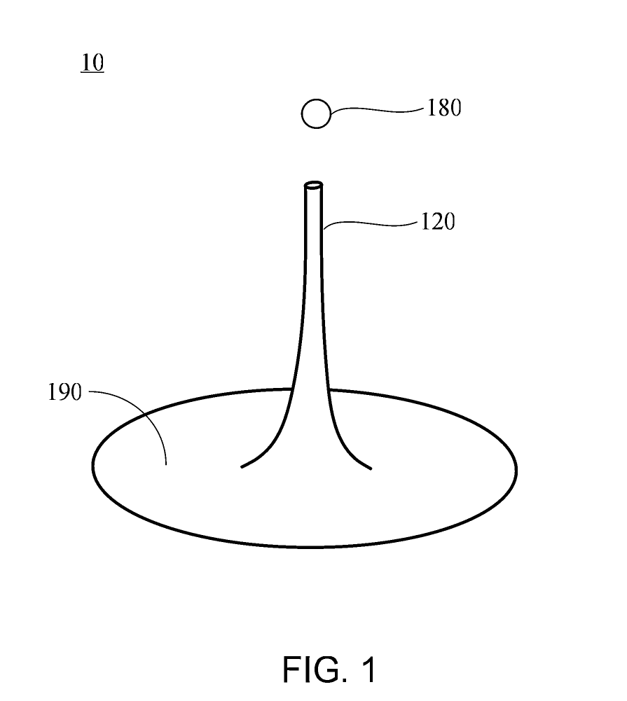

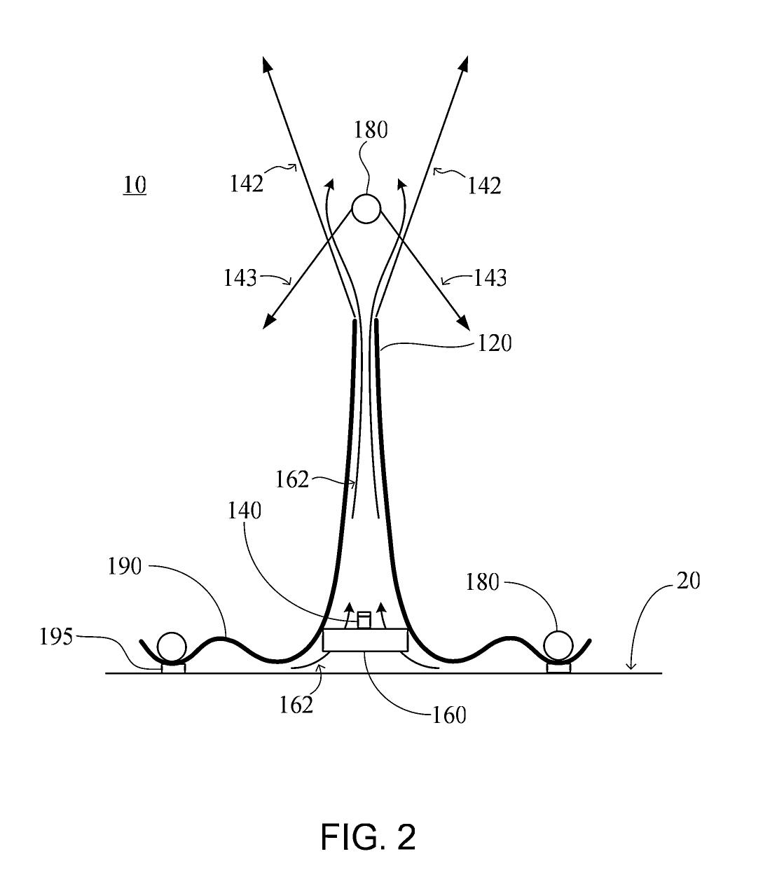

The following will explain the lamp which according to a preferred embodiment of the present invention in detail with drawings. Referring to FIG. 1 and FIG. 2, FIG. 1 depicts a perspective view illustrating a lamp in one preferred embodiment of the present invention, and FIG. 2 depicts a cross-sectional diagram illustrating a lamp according to the preferred embodiment. The lamp according to the preferred embodiment the present invention is generally designated at 10. Preferably, the lamp 10 is placed on a tabletop 20 or on the ground.

The lamp 10 includes an outlet means 120, a luminous body 140, a power generating device 160, a reflective body 180, and a base 190. The outlet means 120 is perpendicular to the tabletop 20 or the ground. In the preferred implement, the outlet means 120 is a convergent tubular body like a horn.

The luminous body 140 is utilized to generate a light beam 142. The power generating device 160 is utilized to generate a power which outputs through the outlet means 120. The reflective body 140 floats above the outlet means 120 by the power for reflecting the light beam 142 of the luminous body 140. In addition, a floating height of the reflective body 140 changes according to strength of the power.

The lamp 10 further comprises a base 190 which is coupled to the outlet means 120 for providing the lamp 10 with a placement of center of gravity, and the base 190 is further utilized to provide a user to place the reflective body 180. As shown in FIG. 2, while stopped using the lamp 10, the reflective body 180 can be placed on the base 190. In the preferred embodiment, the base 190 is integrally formed with outlet means 120 along the divergent tubular body and designed as an extremely aesthetic wave shape. The wave shape not only has the aesthetic purpose, but a plurality of reflective bodies 180 can be placed on the recess of the wave shape in order to replace. However, the base of the present invention is not limited to be the wave shape, and it can also be implemented to be other shapes.

The luminous body 140 is an indirect light source. The luminous body 40 is located inside the outlet means 120, and the light beam 142 is emitted from the outlet means 120. The light beam 142 of the luminous body 40 emitted from the outlet means 120 is indicated as a straight arrow.

The power is magnetic force or airflow. In the preferred embodiment, the power generating device 160 is used for generating airflow 162 (shown in a curved arrow) in the outlet means 120. In the preferred embodiment, the airflow 162 which outputs from the outlet means 120 is an upward airflow. For example, the lamp 10 can be mounted to an air purifier, and the reflective body 180 of the lamp 10 floats above a wind outlet means of the air purifier through the airflow generated from a fan of the air purifier. It is worth mentioning that the lamp 10 further includes a plurality of pedestals 195 in order to make the airflow 162 flow smoothly. The pedestals 195 are utilized to block up the base 190 with a predetermined height, so as to facilitate airflow 162 to flow. Preferably, the predetermined height is interposed between 1 cm and 10 cm. However, the present invention is not limited to be implemented in that the power generating device 160 is disposed inside the outlet means 120. The airflow also can be generated from the outside of the outlet means 120. For example, using an external air hose to coupled to an air conditioner, and other way also can be implemented.

In another embodiment, the reflective body has magnetism, such as permanent magnetism, and the reflective body can float in the air through a magnetic field formed by the power generating device. The user control the strength of the magnetic field of the power generating device by using electrical power, thereby changing the floating height of the reflective body. Moreover, the reflective body can rotate according to a direction of the power. Specifically, the direction of the magnetic field can be control by using the electrical power, so that the reflective body rotates due to the interaction of repulsiveness for like poles and attractiveness for unlike poles between the both magnetic fields. The way to control the strength and the direction of the magnetic field by using the electrical power thereby moving or rotating a permanent magnet or temporary magnet is well known for a person skilled in the art. Thus, no further detail will be provided herein.

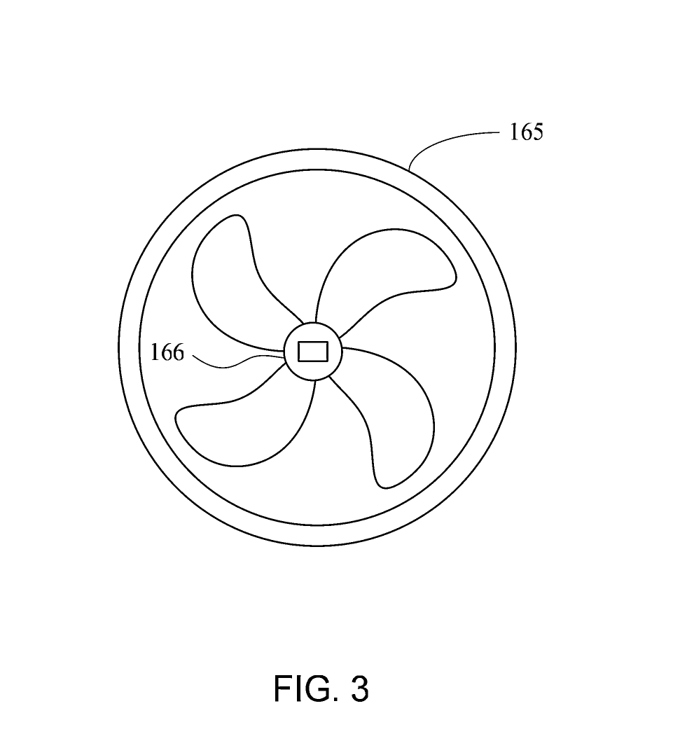

Referring to FIG. 3, FIG. 3 depicts a top view illustrating a fan in one preferred embodiment of the present invention. In the preferred embodiment, the power generating device 160 is a fan 165, and the luminous body 140 is disposed on the fan 165 and located at an axis 166 of the fan 165. This configuration can reduce the air resistance between the luminous body 140 and the fan 165, and the luminous body 140 emits the light beam directly toward the outlet means 120 for increasing light outputted efficiency.

Referring to FIG. 2 again, the reflective body is globular, and the reflective body 180 is movably disposed above the outlet means 120. The reflective body 180 herein floats above the outlet means 120 and reflects the light beam 142 emitted from the outlet means 120, in which the reflected light beam 143 is shown in the drawing. The floating height of the ball is changed according to strength of the airflow 162. It should be noted that the reflective body 180 doesn't fall off due to Bernoulli low and has a shake with a frequent.

In addition, the surface of the reflective body 180 is a reflective surface with various colors, and various changes are formed by replacing different ball. For example, the changes of the light beam by balls with various colors or a mixture of several materials can create brilliant colors of a party or the effect of the light waving in the wind like candlelight. As a result, viewers think that the light is emitted from the reflective body 180 and have a dreamlike feeling like a floating bulb.

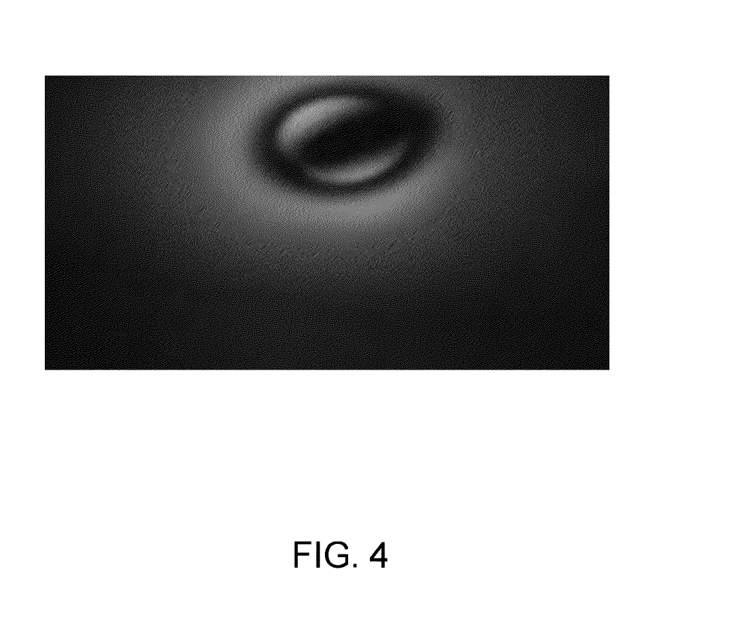

Referring to FIG. 4, FIG. 4 is a pattern illustrating the lamp of the preferred embodiment projecting on a ceiling. Except for the illuminating effect generated form the light reflected by the lower part of the reflective body 180 to the environment, the light beam 142 projected on the ceiling after being blocked by the reflective body 180 forms a projecting effect like an eyeball, which rotates in a frequent, and forms an unexpectedly special environment.

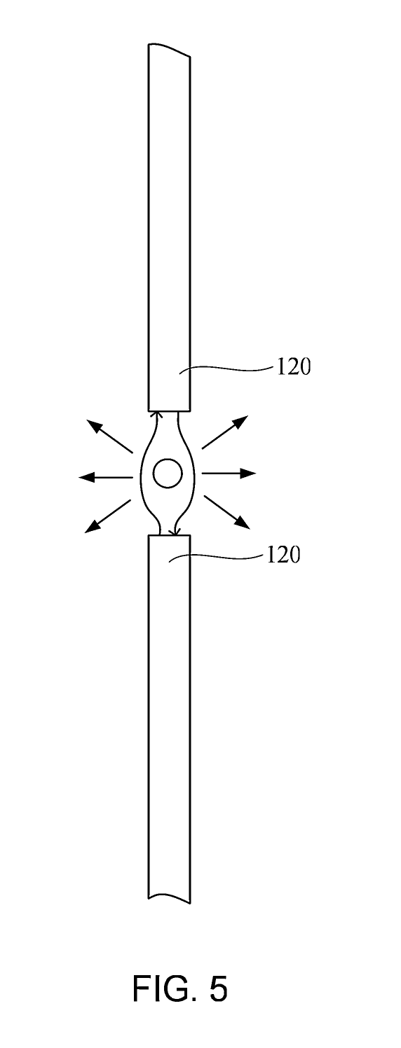

Referring to FIG. 5, FIG. 5 is a schematic drawing illustrating a lamp according to another preferred embodiment of the present invention. The lamp can also be implemented in two opposite outlet means 120 holding a bill. In addition, the lamp with the two outlet means 120 also can be reduced to form a cool hand-held lamp. However, except for using two opposite outlet means 120 to hold a bill, it also can be implemented by using three or more outlets toward the ball for controlling the ball floating.

In summary, the present invention the height of the luminous ball can be adjusted by arbitrarily adjusting the strength of the airflow in the present invention. The luminous ball can be replaced easily for quickly creating different luminous effect in the present invention, whereby the user can change the atmosphere of the environment more convenient and easy. The drawbacks that the luminous body of the conventional lamp is uneasy to replace and the light beam has only regular changes are solved.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A lamp, comprising:
a luminous body for generating a light beam;
a power generating device for generating a power which is outputted through an outlet means; and
a reflective body, floating above the outlet means by the power, reflecting the light beam of the luminous body.

2. The lamp of claim 1, wherein the luminous body is an indirect light source.

3. The lamp of claim 1, wherein the luminous body is located inside the outlet means, and the light beam is emitted from the outlet means.

4. The lamp of claim 1, wherein the power is a magnetic force.

5. The lamp of claim 1, wherein the power is an airflow.

6. The lamp of claim 5, wherein the airflow is an upward airflow which is outputted from the outlet means.

7. The lamp of claim 1, wherein the power generating device is a fan.

8. The lamp of claim 1, wherein the power generating device is a fan of an air purifier.

9. The lamp of claim 1, wherein the reflective body is globular.

10. The lamp of claim 1, wherein a floating height of the reflective body is changed according to a strength of the power.

11. The lamp of claim 1, wherein the reflective body is rotated according to a direction of the power.

12. The lamp of claim 1, wherein the outlet means is tubular.

13. The lamp of claim 1, the lamp further comprising a base which is coupled to the outlet means for providing the lamp with a placement of center of gravity.

14. The lamp of claim 13, wherein the base is further utilized for providing a user to place the reflective body.
